(19) United States
(12) Patent Application Publication
(10) Pub. No.: US 2012/0209839 A1
(43) Pub. Date: Aug. 16, 2012

(54) PROVIDING APPLICATIONS WITH PERSONALIZED AND CONTEXTUALLY RELEVANT CONTENT

(75) Inventors: Anton O. A. Andrews, Seattle, WA (US); Ryan Powell, Seattle, WA (US); Andre O. M. Mohr, New York, NY (US); Jae P. Park, Bellevue, WA (US)

(73) Assignee: MICROSOFT CORPORATION, Redmond, WA (US)

(21) Appl. No.: 13/027,851

(22) Filed: Feb. 15, 2011

(51) Int. Cl. G06F 17/30

(52) U.S. Cl. 707/728; 707/780; 707/740; 707/E17.014; 707/E17.09

(57) ABSTRACT

The technology provides content about a user to a currently executing instance of an application which uses the provided content to personalize and make its processing contextually relevant for a user. When the application instance is launched, a message requesting data related to categories for a user is sent to a context relevant, content aggregation and distribution system. The service executes within a cloud computing system, and provides the application instance with content derived from sources like other applications and data stored on devices the application instance is not or cannot communicate with. The service gathers content from many different types of online resources such as e-mail, social networking sites, websites, and other data accessible over communication networks with different communication protocols.

### BACKGROUND

With the widespread adoption of the Internet, more people have access to more information than ever before, and an application a user may use to access that information wants more and more data on the user to provide more relevant results or processing. Applications are ever looking for ways to track their users. Often, an application relies on a user's history with using its application to provide personalized service. An application often desires to be able to push the most relevant content to a user, but a history is to be built first. Interactions between applications trying to share data to capture a truer picture of a user and the services he or she desires are often one to one sharing encounters and may only provide a glimpse of a user's interests. Furthermore, an application may have limited contextual information about a user during an application instance or session. Despite all the tracking efforts, an application may still miss identifying important relationships and information to enhance the user's experience in using the application.

### SUMMARY

A system automatically and continuously aggregates relevant and current information about the people and things that a user cares about. The information is filtered based on current user context (e.g. where the user is, what the user is doing, what the user is saying/typing, etc.) and/or topics of interest to the user. The result of the information gathering is made available as an API to applications loaded on a computing device (e.g. contacts and Internet Explorer® on a smartphone), and 3rd party applications (e.g. Yelp!® on a smartphone). An application program can interact with a context relevant, content data acquisition and distribution system to obtain information about a wide range of aspects of a user's life. When a user launches an instance of an application program, the information represented in computer accessible form as content can be used by the application program to provide personalized and contextually relevant processing for a user. An example of such processing is generating output that prioritizes content of the highest relevance to the user's context and preferences.

The context relevant, content aggregation and distribution service system may be implemented in a cloud computing system or environment in which computer systems using different communication protocols communicate. Furthermore, the context relevant, content aggregation and distribution service accesses different online resources of different types, some of which are publicly accessible, and some which are private in that they require credentials to access. The content service can provide content, for example a recommendation, based on user data stored by one application in a user account which a requesting application is not able to access. Additionally, the service can provide content based on user data retrieved from another application with which the requesting application is not currently communicating. Furthermore, the service can provide content based on user data retrieved from another application executing on another user client device associated with the user.

In one embodiment, the technology provides one or more processor readable storage devices having processor readable code embodied on the one or more processor readable storage devices. The processor readable code can program one or more processors to perform a method for providing personalized content about a user to an application for context relevant processing. The method comprises automatically and continuously gathering content about one or more topics of interest to a user from online resources executing on computer systems accessible via different communication protocols. A request from an application for data describing a user's interest in one or more topics and a context for the user is received. The content gathered for the user is automatically filtered based on the application data request from the application, user profile data and a current user context. Contextually relevant content from the filtered context is provided to the requesting application.

In another embodiment, the technology provides a method for personalizing application processing for a user. By an executing application instance. The method comprises receiving contextually relevant and personalized content for a user from a context relevant, content aggregation and distribution service. The received content is based upon data which the service has received from a different executing application unavailable to the application instance. The method further comprises receiving a context for the user in the content, and outputting content which is personalized to the user and relevant to the context of the user.

In another embodiment, the technology provides a system for providing personalized content about a user to an application instance for context relevant processing. The system comprises one or more datastores storing user profile data including current context data for the user. One or more servers have access to the one or more datastores and are in communication over communication networks with different communication protocols with computer systems executing online resources. The online resources include resources unavailable to the executing application instance.

The one or more servers execute software for receiving a request for selected categories of data about the user from an executing application instance. The one or more servers also execute software for searching and gathering content for the selected categories of data about the user from the online resources. The one or more servers execute software for sending the executing application instance content based on the current context data of the user and the content gathered for the selected categories.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts an embodiment of a cloud computing system for providing personalized content about a user to an application instance for context relevant processing.

FIG. 2 is a block diagram of one embodiment of software components of a system for providing personalized content about a user to an application instance for context relevant processing.

FIG. 3 illustrates embodiments of data categories of user data which may be used in a system for providing personalized content about a user to an application instance.

FIG. 4A is a flowchart illustrating an embodiment of a method for organizing and storing data in user profile data.

FIG. 4B is a flowchart illustrating an embodiment of a method for an application to access data in the user profile data.

FIG. 5A is a flowchart illustrating an embodiment of a method for providing personalized content about a user to an application for context relevant processing.

FIG. 5B is a flowchart illustrating an embodiment of a method for personalizing application processing for a user.

FIG. 6 is a logical block diagram depicting another embodiment of a software architecture for a service system for providing personalized content about a user to an application instance for context relevant processing.

FIG. 7A is a flowchart of a method by which a service client module provides user context information to the service for aggregating and distributing context relevant content.

FIG. 7B is a flowchart of a process by which the service updates the current context for a user.

FIG. 7C is a flowchart of a process by which a service client module indicates user activity to a service for aggregating and distributing context relevant content.

FIG. 7D is a flowchart of a process by which the service searches for content for topics of interest to the user based on the indicated user activity.

FIG. 7E is a flowchart of a process by which the service processes a request from an application instance for data related to selected categories of data.

FIG. 7F is a flowchart of a process by which an application receives and processes contextually relevant content from the service.

FIGS. 8A through 8F illustrate various examples of how an application may modify its processing to provide personalized and relevant content to a user.

FIG. 8G illustrates an example of a user interface in which one or more application icons depict content the application provides and which is personalized to the user.

FIG. 9 is a block diagram of an exemplary computing environment.

FIG. 10 is a block diagram of an exemplary gaming console.

FIG. 11 is a block diagram of an exemplary mobile device.

### DETAILED DESCRIPTION

Smart applications that know what is relevant to a user significantly improve the user's experience in interacting with these applications. Technology described herein allows applications to leverage content such as recommendations from a context relevant, content aggregation and distribution service for personalizing and making contextually relevant the data and services they provide to users. The technology provides embodiments of a context relevant, content aggregation and distribution service which constantly gathers content relevant to a user and an application requesting information about the user from a variety of online resources. The service filters the content relevant to a context of the user and the kinds or categories of data for which the application has requested information. The service provides content, for example a recommendation on user preferences and relevancy scores therefore, to the requesting executing application instance so it can modify its processing in real-time to be personal and contextually relevant to the user.

The content received from the service may also include or indicate a current context of the user. Relevance of content to a user may be determined from information typically stored in a user profile such as the user's demographics data, for example age, gender, and place of residence and identified topics of interests. Topics of interests may be identified by a user explicitly, and the content aggregation and distribution system may identify topics passively, for example by monitoring a user's browsing history and social networking history.

Content is information which is in a form accessible by a computer system. For example, the recording and streaming of a conversation by a smartphone results in streamed audio data which can be processed by a computer. Other examples include video, photographic and audio data stored in computer readable formats as well as text data and computer readable data representing physical sensations (e.g. vibrating smartphone) and movements. Content can also be generated which is derived from other content items.

Some examples of context information which may be used to determine a context for a user are actual physical location as may be provided by GPS, a WiFi connection point, or a cellular transmission point radius, IP address of computer to which the user has logged in, a photograph to which an image recognition technique is applied, photo metadata, time of day and time of year, a computer network connection mode associated with a computer device, for example, work, home, public, etc., who is with the user, for example in a vicinity such as a predefined physical distance, a person associated with a user and participating in an activity, currently or scheduled to do so, an activity the user is performing, an availability of the user based on information stored by a scheduling software application, or what a user is inputting to a user input device of an associated computer device communicatively coupled to the aggregation and distribution system.

The service may be embodied to leverage the power of cloud computing systems. A cloud computer system or environment of systems is able to communicate over communication networks using different protocols. For example, a cloud computing system may be implemented by computers which can interface with different types of communication systems and make the information available in formats for the other computers to access. Some examples of different types of communication systems are various wireless telecommunication systems to receive and forward telephone calls and Short Message Service (SMS) messages, Plain Old Telephone Service (POTS) and ISDN lines as well as computer networking standards such as TCP/IP, Ethernet and the wireless 802.11 series connection protocols.

The service provides advantages over other data discovery systems in that content is gathered from many different types of online resources such as e-mail, social networking sites, websites, and other data accessible via online communication networks. Additionally, the content provided to the application can be derived from user data gathered across many of a user's different types of computing devices.

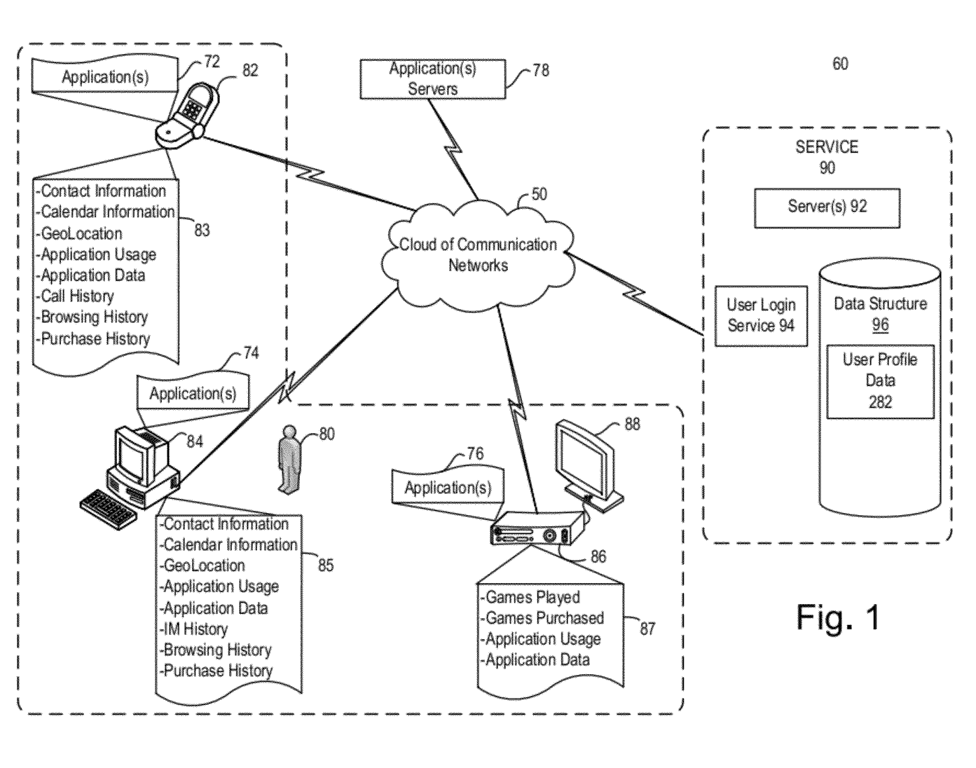

FIG. 1 depicts an embodiment of a cloud computing system 60 for providing personalized content about a user to an application instance for context relevant processing.

The system 60 comprises a plurality of computing devices 82, 84, 86 belonging to a single user 80. In one example, computing device 82 may be a mobile telephone of a mobile telephone network, computing device 84 may be a personal computer such as a desktop computer, laptop computer or tablet, and computing device 86 may be a set-top box or game console having an associated display 88. The computing devices 82, 84, 86 may also be connected to a service 90 via a cloud of communication networks 50. Example embodiments of these computing devices are set forth below with respect to FIGS. 16, 17 and 18.

Each of the computing or client devices 82, 84, 86 can execute applications 72, 74, 76 locally or via servers 78 accessible via the cloud networks 50. Some examples of applications executing on servers 78 are social networking sites, websites from which purchases for goods and services can be transacted, user service accounts like media download sites and financial sites, and Internet service providers like online gaming services, e-mail services and search engine websites.

Each of the various types of computing devices may store data locally and “in the cloud,” for example in a user profile data storage location 282 in service 90 as explained below. Each device may have the same data, different data or different versions of the same data. As an example, mobile device 82 may include information 83 having data such as contact information, calendar information, geographic (geo) location information, application usage data, application specific data, a user's messaging and call history, browsing history and purchase history. The personal computing device 84 may include information 85 having data such as contact information, calendar information, geo location information, application usage, application data, instant message (IM) history as well as browsing and purchase history for an associated user 80. Gaming console 86 may include information 87 such as a history of games played, a history of games purchased, a history of which applications are played most by user 80, and application data, such as achievements, awards, and recorded sessions.

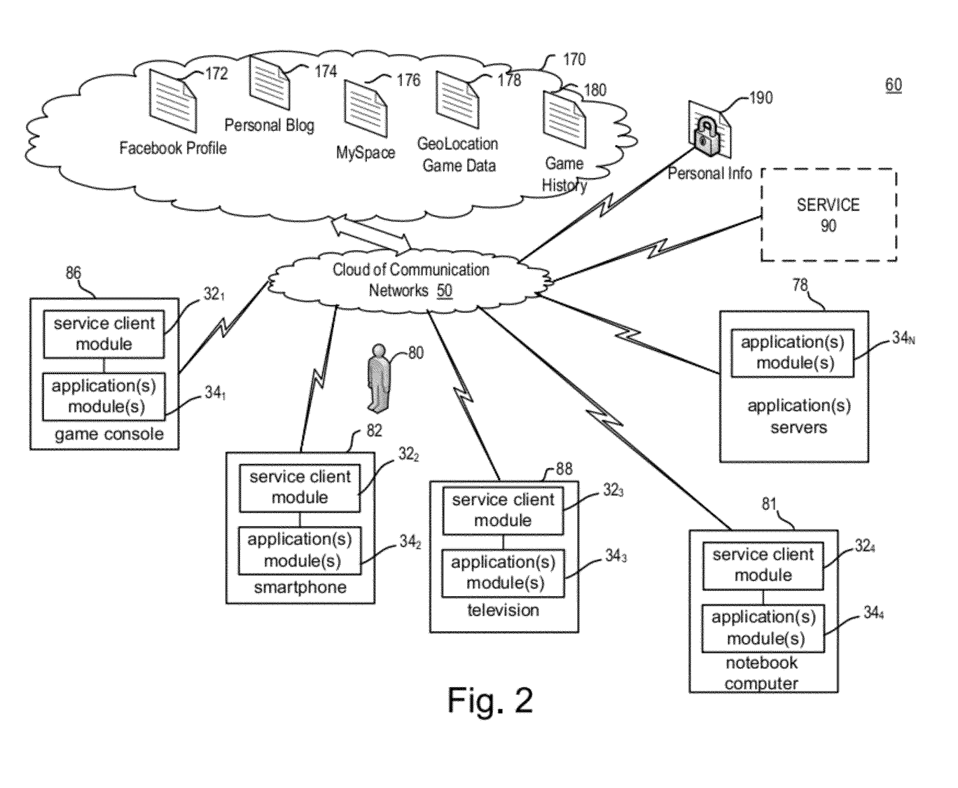

In addition to a real world social interaction, users can engage in virtual social interactions. For example, user 80 may engage in an online game with other users (such as those shown in FIG. 2). In the game, the users may interact not only by playing the game, but also by verbal or messaging communications between them from which communication applications can store data.

The computing devices 82, 84, 86 shown in FIG. 1 are by way of example only and one or more of these may be omitted in further embodiments. Moreover, the user 80 may have a variety of other computing devices, or additional replicas of the computing devices 82, 84, 86, in further embodiments. Such computing or client devices may in general include, but are not limited to, desktop computers, laptop computers, tablets, cellular telephones, smartphones, televisions/set top boxes, video game consoles, automobile based computer systems, cameras and smart appliances. Other computing devices are contemplated.

The service 90 is a context relevant, content aggregation and distribution service executing on one or more computing devices of servers 92, which may for example include a database management service 218 as explained below. In embodiments, each of the computing devices 82, 84, 86, 92 illustrated in FIG. 1 may be coupled to each other via one or more public or private networks 50. Network 50 may include the Internet, cellular networks, or any other type of known public or private data and/or voice transfer network. In further embodiments, computing devices 82, 84, 86, 92 may be connected to each other by peer-to-peer connections in addition to, or instead of, their connection to network 50.

The service 90 also provides a user login service 94, which is accessed by a user client device 82, 84, 86 to authenticate the user 80 to the context relevant, aggregation and distribution service. A user 80 may authenticate him or herself to the service 90 by a variety of authentication protocols, including for example with an ID such as a username and a password. A single sign-on procedure may be used in which the user permits the service 90 to maintain sessions with the user's private accounts, e.g. e-mail accounts, gaming service account, social networking sites, financial services accounts like credit cards and pay-by-phone accounts.

Where authentication is performed by the service 90, the ID and password may be stored in user profile data 282 within a data structure 96. User profile data 282 may store a wide variety of data including actual content gathered, content derived from gathered content, and content inferred about a user from gathered content. While servers 92, login service 94 and data structure 96 are shown as part of a single service 90, some or all of these components may be distributed across different networks 50 in further embodiments.

FIG. 2 is a block diagram of one embodiment of software components of a system 60 for providing personalized content about a user to an application instance for context relevant processing. The exemplar user client or computing devices of FIG. 1 plus a notebook computer 81 each include a client module 32 and an application module 34. The application servers 78 also include application modules 34 which represent executing instances of the various applications available for execution. Some examples of applications are web browsers, search engines, predictive texting programs, contacts management and calendaring software, websites (e.g. Yelp®), games, e-mail and online gaming services.

In operation, a user 80 may use any of her associated client devices 81, 82, 84, 86 (at different times or concurrently) in order to perform various tasks (e.g., work, entertainment, social, etc.). These devices have service client module software 32 embodied or stored on processor readable storage media like a memory, which may be in any of a variety of forms, volatile or non-volatile, and which executes on a processor in one or more of these devices. While operating these devices, a user 80 indicates topics of interest via her actions which are tracked and communicated to the cloud based service system 90 by the client module software 32 executing on the one or more devices. Some examples of such actions are types of sites visited and how often and when within a time period during Internet browsing (a user's visits to various baseball sites beyond a threshold can trigger the service to add baseball as a topic of interest), checking e-mails, telephone calls, text messages, videos and photos downloaded, the metadata for downloaded audio, video, photographic and other types of media files, data stored, search terms, and search results reviewed, search results not reviewed, posts to social networking sites, and explicitly entering topics to a topics list, and other users the user interacts with or has data for such as in a data structure defining relationships like a friend's list.

Additionally, by gathering information from sources such as IP addresses which computers a user is logged into, computer network connection mode designations (e.g. work, home, public), Global Positioning System (GPS) modules, WiFi connection nodes, time of day, calendars, schedules, a subscriber identification module (SIM) for a mobile phone, applications being executed on a user computer device (e.g. a document processing application or a game) and the like, the client module software executing on the device can determine contextual information for the user and communicate this contextual information to the service 90 via the cloud of networks 50. The cloud based service system 90 may determine a context for the user based on contextual information derived from information from a variety of devices and online resources, such as some applications 34_{N} which the service 90 may contact for content aggregation and distribution.

Each of the devices illustrated in FIG. 2 may be coupled to each other and cloud services via one or more public or private networks 50 as described above.

In addition to service 90, FIG. 2 further shows data structure 96 as a cloud-based data store for storing information 170 which includes public and/or private information for a user 80, and is stored on a network accessible data store 96 which is available via cloud networks 50. Public information 170 may for example include a Facebook profile 172, a personal web log 174, a MySpace® profile 176, geo location presence 178, and/or gaming history 180. Cloud information may further include private data 190 accessible via the cloud, wherein the private data 190 may include things such as purchasing records, banking history, and purchase transaction history via any other number of known vendors. In one embodiment, private data 190 is only accessible based on authorized access by the owner of the private data.

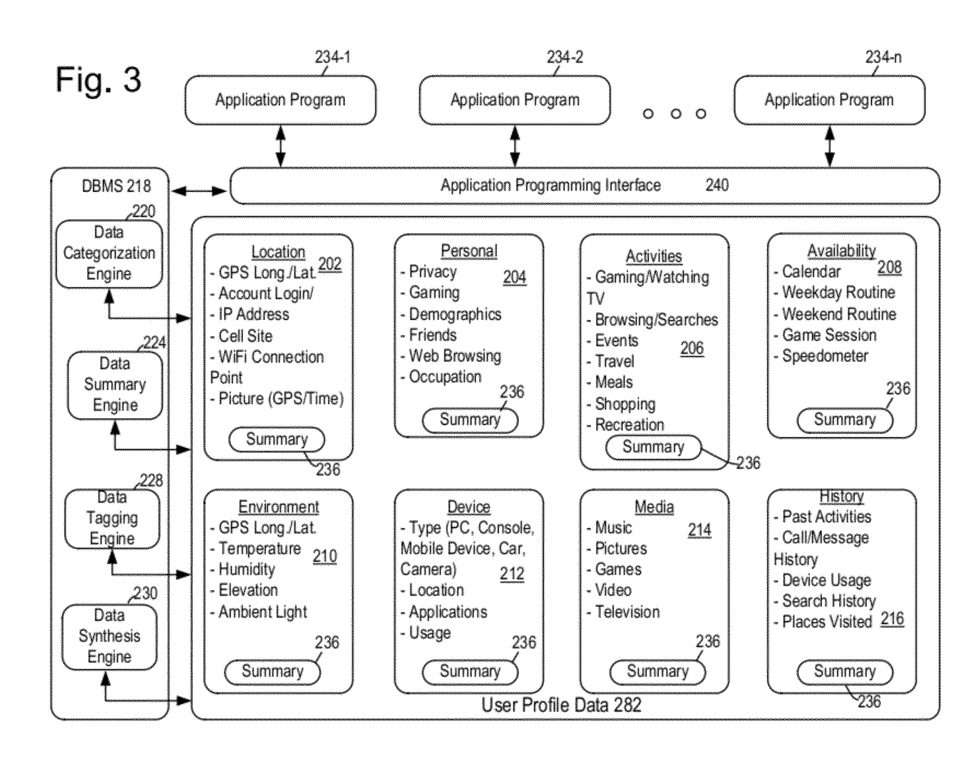

FIG. 3 shows a block diagram of one example of user profile data 282. The user profile data 282 may for example be, or include, a relational database, such as for example an SQL Azure™ Database built on SQL Server® technologies. Other types of databases are contemplated. The user profile data 282 may include a plurality of categories, categories 202, 204, 206, 208, 210, 212, 214, 216 in this example, each including a different category of data. The service stores for each user its own set of categories 202 through 216 including data gleaned from the user's own computing devices 82, 84, 86 and other computer systems she interacted with in online activity. Such gleaned data may represent data and activities which indicate topics of interest to a user which can be found within categories.

The present system further includes an API 240 which allows the data to be uploaded and accessed as a whole, as explained below. This provides an enhanced view of a user and his experiences, integrated across all of a user's computing devices, and online activity.

The type of data which may be stored in categories 202 through 216 may be any type of data about a user. The term “user” here is defined broadly to include a user as well as objects and/or entities with which a user interacts. In this context, a user would include people, but may also include a car, a house, a company, etc. It may be gleaned from one, more than one, or all of a user's computing devices, but it may come from sources other than the user's computing devices as well (e.g. online gaming service). By way of example only and without limitation, the categories 202 through 216 into which a user's data may be broken down in FIG. 3 include location data, personal data, a user's activities, a user's availability, a user's environment, devices a user has, media the user has accessed and a user's history.

Location data category 202 may in general include data about a user's current position, and may be given by any of a variety of data extracted from one or more of a user's computing devices. This data may be given by a global positioning service (GPS) receiver in a computing device, such as a mobile telephone 82 carried by a user. Location data may further be given by a user account login at a computing device of known location or by a known IP address. The location data may further come from a cell site picking up a mobile phone, or it may come from a WiFi connection point to which the user is connected, where the location of the WiFi connection point is known. In embodiments, pictures taken by a user may include metadata relating to a time and place when the picture was taken. This information may also be used to identify a user's location in real time when the picture is taken. Other types of location data are contemplated.

The category 204 may have personal data including a user's privacy settings among other information. The present system pushes a large amount of information about users to requesting applications. Each user has the ability to establish privacy settings about how much of their data and personal information is shared. A user may opt-out of sharing their data with requesting applications altogether; a user may put in place privacy settings that share their data only with certain users, such as those on their friends list; and a user may setup their privacy settings so that only portions of their data having a privacy rating below a certain threshold are shared. These settings may be manually set by a user through a privacy interface provided by the service 90.

The personal category 204 may further include a variety of other user personal data such as their gaming statistics (gamer profile statistics, games played and purchased, achievements, awards, recorded sessions, etc.); their demographics such as a user's age, family members and contact information; their friends list; browsing and search history; and their occupation information. Other types of personal data are contemplated.

The activities data category 206 in general includes data on what a user is doing in real time. This data may be generated in a variety of direct and indirect ways. Direct methods of gathering such data are provided for example by a console or set top box to show that a user is playing a game or watching TV. Similarly, a user's PC or mobile device may show what browsing and web searches a user is performing A user's device may show that a user has purchased a ticket to an event, or has made certain purchases relating to travel, meals, shopping and other recreational activities (these purchases may occur in real time, or made for some time in the future).

Activities data category 206 may include a variety of other activities that may be directly sensed by their computing devices and uploaded in real time to user profile data 282. In further embodiments, activities data for category 206 may be obtained indirectly, such as for example by a synthesis engine 230. Synthesis engine 230 is explained in greater detail below, but in general the engine 230 may examine data within the various categories in user profile data 282 to infer further data, which may then be added to the user profile data 282. For example, if a user is taking photos, and the photos are recognized as a tourist attraction, the synthesis engine 230 may infer data for activities data category 206 that the user is on vacation and/or sightseeing. Various other types of activity data may be provided in activity data category 206.

The availability data category 208 may show a user's availability in real time. A good source for this information may be a user's calendar as it is updated from any of his or her computing devices and maintained in a central data store (either as part of service 90 or elsewhere). However, other indicators may also be used to establish a user's availability. For example, a user's availability may be inferred from established daily routine on weekdays and weekends through her activities and purchases as detected by her computing devices. Availability may be indicated by what activities a user is performing (as stored in the activities category 206). For example, if a user is in a gaming session, it may be assumed that a user is not then available. Availability data for category 208 may further be inferred indirectly from synthesis engine 230 from other data. For example, if a user's car (or other device) indicates that a user has begun traveling in the car at high speed, and the user's calendar shows that the user has an offsite meeting, the synthesis engine may infer that the user is driving and unavailable for some period of time. Other types of availability data are contemplated.

Environmental data in category 210 may include empirical measurements of a user's surroundings, such as for example current GPS position, temperature, humidity, elevation, ambient light, etc. In the above examples, GPS data is included in location and environment data categories 202 and 210. This shows that at least certain types of data may be included in more than one category.

Device data category 212 may include the types of computing devices a user has and the locations of these devices. Data category 212 may further include the applications loaded on these devices, how often and when these devices are used, and application data. Other types of data may be included in the device data category 212.

Media data category 214 may include any media that the user is then viewing or listening to, or has accessed in the past. This media may include information such as music, pictures, games, video and television. The media data category 214 may include stored copies of this media, or merely a metadata listing of what media the user is or has accessed and, if stored on a user's computing device or storage location, where the media is stored.

History data category 216 may include a historical view of what the user has done in the past. One feature of the present system is the ability to upload user data and make that data available for consumption in real time, as explained in greater detail below. However, historical data may also be stored. Such historical data may include past activities (i.e., data that was stored in activities category 206, but was moved to historical data category 216 once the user was finished with the activity). History data category 216 may include telephone and/or message history (SMS, instant messaging, emails, etc.), and a history of computing device usage and web-browsing/searching. It may further include history of where a user lived, worked, visited, etc. Historical data in category 216 may be only a few seconds or minutes old, or it may be years old.

The above information in categories 202 through 216 is by way of example only. In addition to the data set forth above, user profile data 282 may further include, without limitation: data from cloud information 170 (FIG. 2) and other social web sites such as Facebook, Four Square®, Twitter® and My Space; service data, such as that which may be available from gaming services such as XBOX LIVE®; social graphing data, including friends, friends of friends, family and other socially defined relationships, and exposed data from friends of the user and other levels of the social graph. A wide variety of other data and other data categories may be provided in user profile data 282.

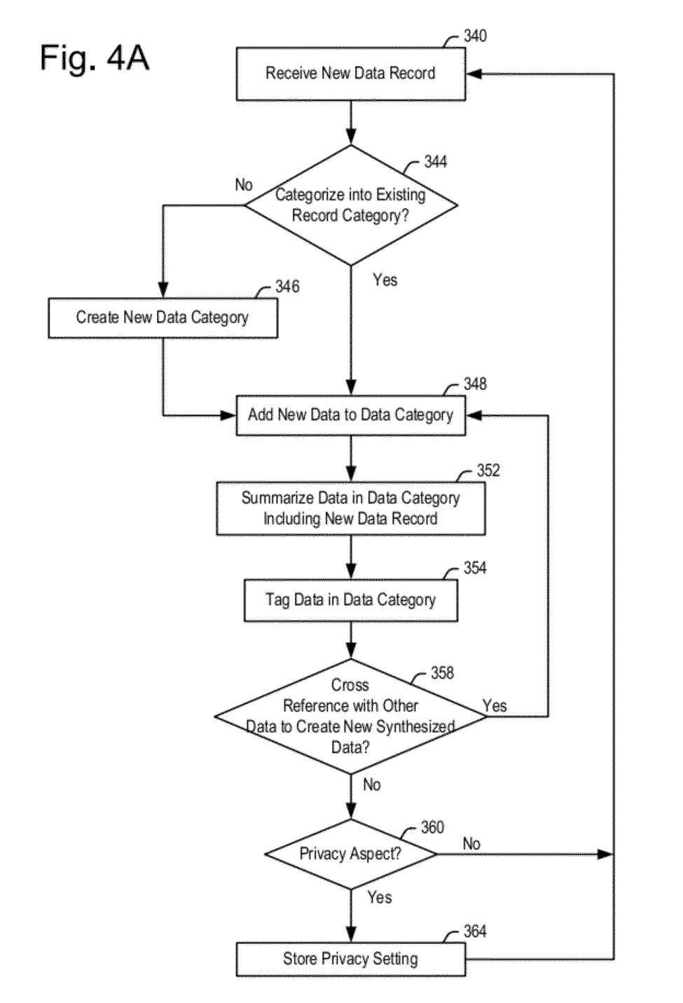

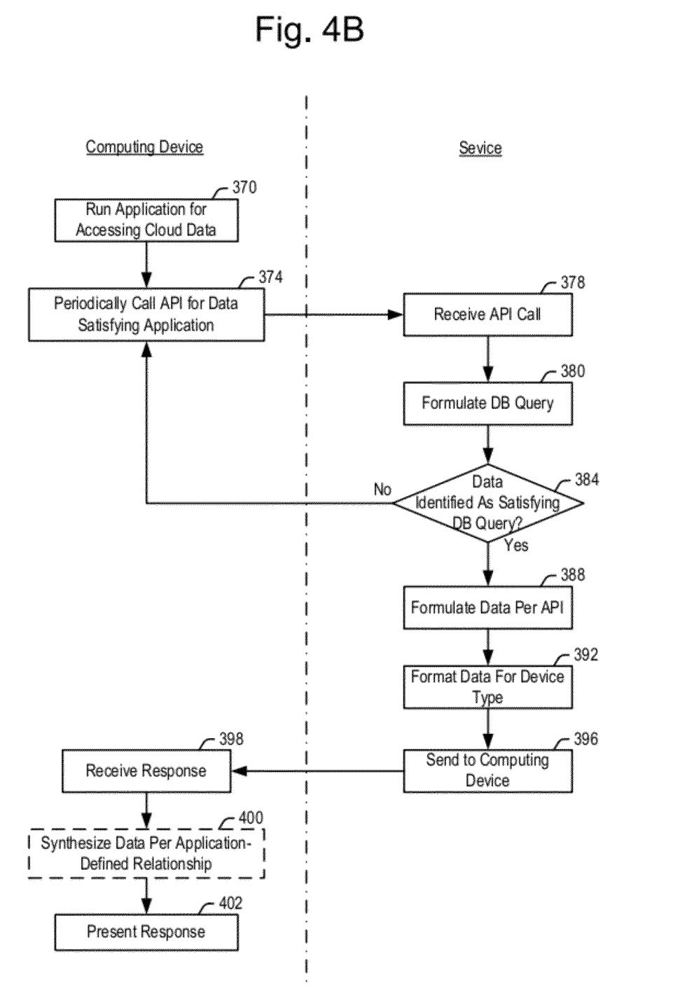

Once data is uploaded to the user profile data 282, various processing operations may be performed on the data under the control of DBMS 218 as shown in FIG. 3. DBMS 218 is disclosed by way of an example only. It is understood that the processing operations described below may be performed by control algorithms other than a DBMS in further embodiments. Whether performed by DBMS 218 or some other control, these processing steps may include one or more of categorizing the data into categories, summarizing the data, tagging the data and checking whether new data may be synthesized from the detected data. These operations are explained below with reference again to FIG. 3 and the flowchart of FIG. 4A.

In step 340, new data from a user computing device is received. In step 344, the data categorization engine 220 checks whether the received data may be classified into an existing data category. The data categorization engine 220 may be a known component of the DBMS 218 for setting up fields, a set of relations for each field, and a definition of queries which may be used to access the data associated with the different fields and relational sets. Given a set of predefined constraints, the data categorization engine 220 is able to sort received data into the different categories, as well as detecting when a new category is needed for new data. Categorization engine 220 may use known methods to sort data into categories and/or create new categories. A database administrator may also monitor the user profile data 282 and facilitate the operation of the data categorization engine 220 to categorize data and determine when new data categories are needed.

If the data categorization engine 220 determines that new data fits within a defined category, that data is added to that category in step 348. If the engine 220 determines that new data necessitates a new data category, the engine may create that new category in step 346, and the new data may be added to that new data category in step 348.

In step 352, the data for a given data category may be summarized by a data summarization engine 224. In particular, when new data is received, it may have some indicator of the reliability of that data, such as for example a confidence value. The reliability indicator may for example be based on the known accuracy of the source, and whether the data was measured directly by a computing device or inferred from the synthesis engine explained below. A variety of other factors may go into determining the confidence value for a reliability indicator. A reliability indicator may remain as a constant, or it may decay over time. For example, location data is best in real time, but is less reliable as the location data grows older.

In one embodiment, the summarization engine 224 analyzes the reliability indicators for each data record in a category, and determines a summary 236 having an optimal data value representative of the category of data values. It may be based on a determination that reliability indicators show that one data value is more reliable than the other data values. For example, GPS data may be more reliable than an IP address for giving a user's location. In such embodiments, the summarization engine 224 may return a summary 236 having the data associated with the highest reliability indicator. In further embodiments, the summarization engine 224 may return a summary 236 having a composite value based on several reliability indicators. The summarization engine 224 may return a variety of other factors, including overall reliability of the data, median values and standard deviations.

As an example of the operation of the summarization engine 224, the user profile data may have multiple location data inputs (GPS latitude/longitude, WiFi node, etc.). The reliability indicator for these data values may include information such as the signal strength of the GPS signal, and the range of the WiFi network. Using the reliability indicators, the summarization engine 224 may determine to use one data point and discard the other. Alternatively, the summarization engine may use more than one data point to create a summary 236 having a composite location with a single summary value (e.g., latitude/longitude) or multiple data points (e.g., latitude/longitude plus an overall reliability score).

In step 354, a data tagging engine 228 may be used to provide a metadata tag on at least certain items of data. In particular, data items in a category may be tagged with descriptors for use in any of a variety of ways to facilitate use of that data across a variety of computing devices, application programs and scenarios. Some computing devices may need that data formatted in a specific way, which information may be provided in a metadata tag. Some application programs may use the data in one way, while other programs use the data in another way, which information may be provided in a metadata tag.

The metadata tags may be generated by the data tagging engine 228 and associated with a particular item of data. The data tagging engine 228 may generate the tags based on predefined rules as to how and when data is to be tagged, which information may be provided by DBMS 218. Alternatively or additionally, the tagging engine 228 may make use of metadata uploaded with an item of data.

The synthesis engine 230 next checks in step 358 whether items of data within the user profile data 282 may be used individually, or cross-referenced against other items of data, to synthesize new data. In particular, an administrator may create rules stored in the DBMS 218 which define when logical inferences may be drawn from specific data types to create new items of data. A few examples have been set forth above: use of a car's speed data together with calendar appointment data may be used to infer data regarding a user's availability; recognition of the subject of a user's photographs (for example by known photo recognition techniques) may be used to infer new data that the user is on vacation and/or sightseeing. A wide variety of other predefined rules may be provided to define when logical inferences may be made about data in user profile data 282 by the synthesis engine 230 to deduce new data.

The data in store 282 may be processed by one or more of the engines 220, 224, 228 and 230 as described above. It is understood that one or more of these processing steps may be omitted in alternative embodiments.

Either before or after the above-described processing steps, the system may check in step 360 whether received data has some privacy aspect associated with it by the user or by the DBMS 218. Each user has the ability to establish privacy settings about an item of data, specifying if, and by whom, the data may be viewed. A user may associate a specific set of privacy rules with each item of data setting forth in detail the privacy settings that are to be associated with that item of data. Alternatively, a user may simply assign a general privacy rating to an item of data. This general rating may then be used by the DBMS 218 to set up a privacy hierarchy of the data. With this hierarchy, a user may specify a threshold privacy setting, for example in their profile data. In so doing, the user agrees to allow access to all data with a privacy rating below (or above) the specified threshold setting. This allows a user to apply privacy settings to a broad range of data quickly and easily. The user may also easily change the privacy settings for a broad range of data in this manner.

In step 360, the DBMS 218 may check whether a new piece of data has an associated privacy setting, such as for example a detailed rule and/or a general rating. If so, the privacy setting may be stored as described above in the profile category 204 in step 364.

Once the data has been uploaded, processed and organized, it is available for access by one or more application programs. An embodiment of this process is now described with reference to FIG. 3 and the flowchart of FIG. 4B. In step 370, a user may execute an application program from one of their computing devices, such as for example one or more of the application programs 234-1, 234-2, . . . , 234-n. Any one of these application programs may cause the computing device to periodically call an API 240 for accessing user profile data 282.

In accordance with the present technology a single, generalized API 240 may be used to expose the full range of a user's data in store 282, across all data categories and for all device types, to the accessing application program. In particular, the API is able to formulate a query, based on the objectives of the accessing application program, to search the sum-total of a user's data and data categories, for all fields which satisfy the query.

As noted above, conventional systems may have provided multiple APIs which allow a view into disjointed segments of user data. However, conventional APIs did not provide access to the full scope of data stored in user profile data 282. The operation of API 240 to expose the full range of data and data categories allows a clearer picture and enhanced experiences relative to what was accessible through conventional and/or disparate APIs. For example, the present system allows a user to interact seamlessly with his various computing devices, to have them act in concert instead of as discrete processing devices.

Referring again to the flowchart of FIG. 4B, once an application program 234 makes an API call in step 370, the API 240 receives the call in step 378 and formulates an object-based query in step 380 to search across all categories for data that satisfies the call. In step 384, the DBMS 218 may retrieve the data fields responsive to the query. In step 388, the retrieved data fields may be formulated into a response for forwarding to the computing device. Different devices have different capabilities, and the response data may be formatted for the particular accessing device in step 392 (or formatting instructions may be forwarded with the response). The response is then sent to the computing device in step 396 and received in the device in step 398.

As noted above, the synthesis engine 230 may synthesize data stored in user profile data 282. It may happen that the application program 234 queries the user profile data 282 for disparate pieces of data, and then performs a synthesis step which is separate than the operation performed by the synthesis engine 230. If so, the separate synthesis step on the returned data may be processed by the application program 234 in step 400. Step 400 is shown in dashed lines as it is optional and may be omitted. The formulated response may be presented over the receiving computing device in step 402. It is noted here that “presenting” the response may mean a visual or audible response over the receiving computing device. It may also mean executing a program on the computing device, or performing some other action on the computing device.

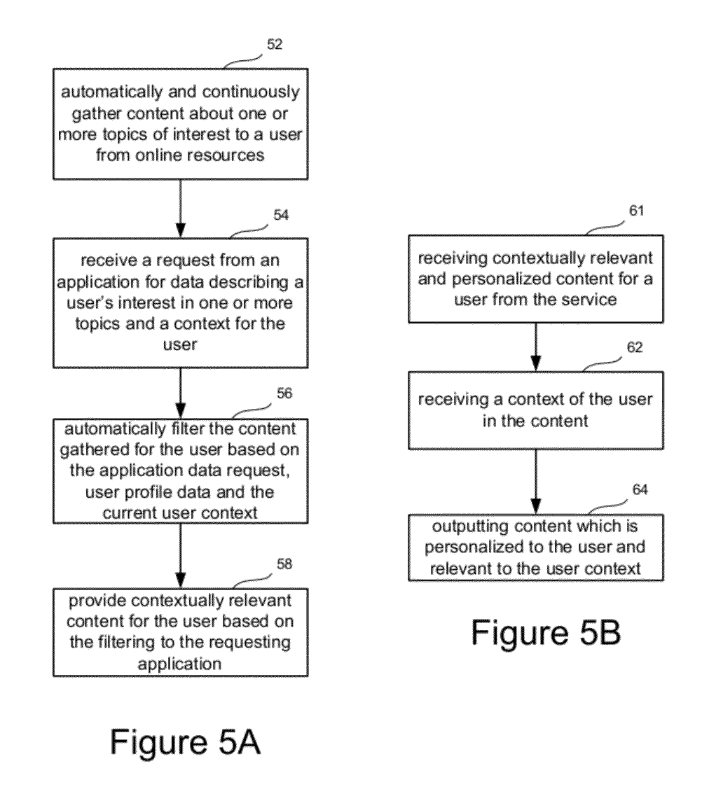

Embodiments of computer-implemented methods performed from the application perspective and a context relevant aggregation and distribution service perspective are illustrated in FIGS. 5A and 5B. The methods may be implemented by the system embodiments discussed above and further below, and in other system embodiments.

FIG. 5A is a flowchart illustrating an embodiment of a method for providing personalized content about a user to an application for context relevant processing. A service like service 90 in step 52 automatically and continuously gathers content of interest to a user from online resources. In the course of this ongoing continuous, gathering of content, the aggregation and distribution service 90 receives in step 54 a request from an application for data describing a user's interest in one or more topics of interests and a context for the user. The data describing the user's interest may be derived from content from online resources as well as from stored user profile data such as demographics data and browsing history.

The content gathered for a user by the service on a topic typically will include content from at least one other application not in communication with the requesting application. For example, a news service website not requesting content from the service may be able to access content about a user's friends list in a social networking user account the user is logged into on the same computing device as per a relationship between the news service and the social networking site. However, the news service will not be able to access content based on an application the news service does not have a relationship with, or to which the user is not logged in currently on that device. The aggregation service provides content to the requesting application based on data received from one or more applications unavailable to the requesting application. Furthermore, the aggregation and distribution service 90 may provide content in the form of recommendations based on user data from private accounts the news service does not have access to such as an e-mail account. Moreover, the new service, unlike the aggregation service, does not have access to applications executing on other devices of the user, but which are not executing the news service. The aggregation service 90 provides data from across devices and across time and which is contextually relevant.

In step 56, the gathered content is automatically filtered based on the application data request, user profile data and the current context of the user. In step 58, the aggregation service 90 provides contextually relevant content for the user based on the filtering to the requesting application.

FIG. 5B is a flowchart illustrating an embodiment of a method for personalizing application processing for a user. The method embodiment of FIG. 5B is performed from the perspective of an executing application instance. An executing application instance may be, for example, an application module 34 executing on a client device, on a server, or an application server module 34 and an application client device module 34 operating together to perform the steps. In step 61, the application instance receives contextually relevant and personalized content for a user from the service, and receives a context of the user in the context in step 62. Steps 61 and 62 may occur at the same time. In step 64, the application instance performs processing personalized for the user by outputting content which is personalized to the user and relevant to the user context.

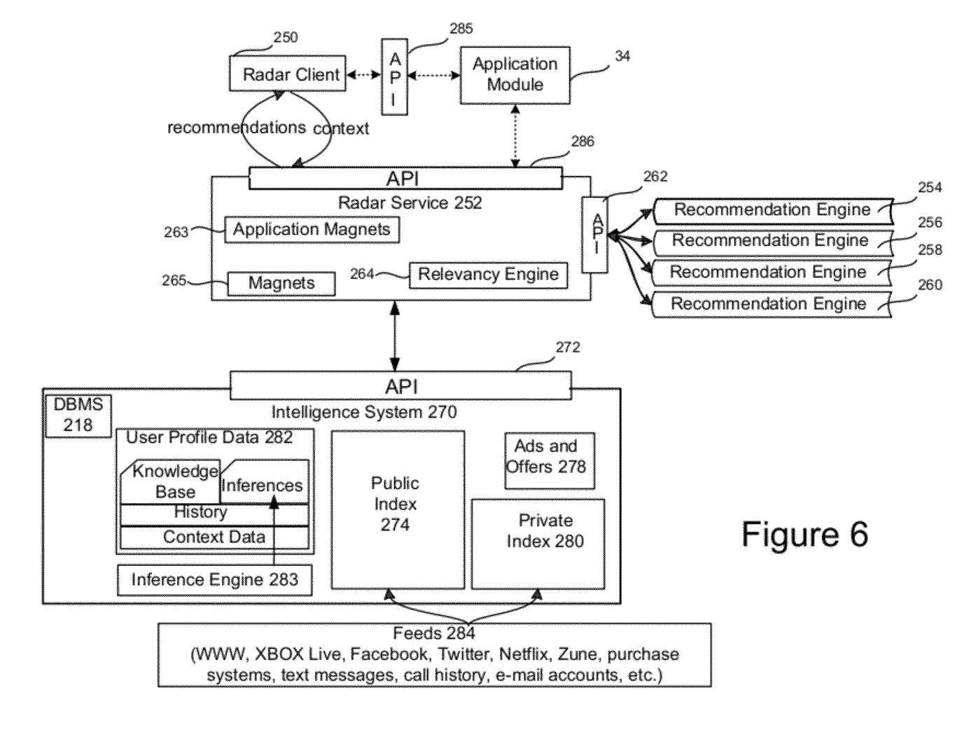

FIG. 6 is a logical block diagram depicting another embodiment of a software architecture for a service system for providing personalized content about a user to an application instance for context relevant processing. The service is cloud based in that it operates within computer hardware which communicates over different types of communication networks using different communication protocols.

In this embodiment, an example of a client module 32 identified as a radar client 250 is software running on any of the physical computing devices of a user which is in communication via a software interface such as the exemplar application programming interface (API) 286 with one or more applications of a cloud based, contextually relevant content aggregation and distribution service, referred to here as a “radar” service 252. Furthermore an application module 34 communicates with the radar service 252 through the API 286 as well. Optionally, the application module 34 may interact with the service via an API 285 with the client module 250. A software developer can modify an existing application to initially register with one or more of the APIs 286, 285 and to set-up the formats for data exchange between the service and instances of the application when executing. The developer programs the initial set of data categories and the selectable items within them which the API publishes for use by the application. The API from time to time publishes new data categories as they may be created, and the application selected categories are updated.

Like a radar, the service 252 and client modules 250 search for information and track it. A radar client 250 provides context information (and, optionally, information about a user's interest) to radar service 252 and receives back content such as recommendations for a user account. In this embodiment, the application module 34 sends a message with selected data categories, user identification information, and application and instance identification to the service and receives content from the service as well, some examples of which are user demographics data; context data such as location, current activity, availability; history and one or more recommendations for a user for whom processing is being done in a current executing instance. Some of the requested data may be retrieved by the service 252 via a database search of user profile data 282 which forms part of an intelligence system 270 discussed below. For example, database management software 218 may be contacted by the radar service via another API 272. For example, demographics data and other personal information like friends or demographic date for the friends as allowed by privacy settings may be sent initially from the stored user profile data 282 and any updates based on results of the application magnets sent later. Current context data may also be provided to the application module 34 which may be updated by the application magnet.

The cloud based radar service 252 includes an API for a set of recommendation engines 254, 256, 258 and 260, each of which makes different types of recommendations for different types of content. For example, one recommendation engine may make recommendations for music, another for shopping, another for parties, another for restaurants, etc. A system can have more than four recommendation engines. The radar service 252 includes magnets 265, application magnets 263, and a relevancy engine 264.

The magnets 265 are software processes that automatically and continuously collect content about a topic of interest (e.g., person, place or thing). For example, magnets look for content (via cloud 50) relative to a seed (e.g., topic or specific content). Magnets for a user are persistent software processes which can collect data about a user even when the user is not logged into the radar service. For example, if a magnet is provided with a seed topic (e.g. a type of shoes, musical group, a subject matter, etc.) then the magnet will search the Internet (or other source) to find content available that is related to that seed. What makes the magnet different from a typical Internet search engine is that magnets are persistent, personalized based on information the magnet retrieves about a user as may be stored in a user profile, and other user information stored by other services and databases to which the service 252 has access via interfaces like those accessible via the intelligence system 240. For example, another service may be a social networking site or an online gaming service such as XBOX® Live which stores a user's gaming statistics and preferences. A magnet may also use context in its searches and can interact with other magnets, can show many types of content (games, music, tweets, search terms) from both public (e.g. 274) and private (e.g. 280) indexes, and the content that is returned has context (such as returning a place and saying who else is there). One or more magnets may be defined to search for content of a user account which is relevant to the context of a user.

An application magnet is a type of magnet which searches for categories of data about a user selected by an executing application instance represented by the application module. An application magnet may receive data updates for its selected categories of data to search from the application instance as it is executing. For example, a user may have navigated on a consumer review website for products and services like Yelp® from restaurants to computer hardware. The application personalizes the content in real-time for the user, so the service provides the information quickly.

An application magnet may be created and may persist for the duration of the application instance, for example, until the user exits that session with that application instance. Like other magnets, an application magnet may be generated on the fly or an existing application magnet may be updated to include new search terms when an update to the selected categories is received from the instance 34 via the API 286 or indirectly via the API 285 from the client module 250. An application magnet may search and make recommendations for the application which are personalized and context relevant. The application magnet may instead or additionally communicate with existing magnets which persistently search for topics of interest for a particular user, which topics may fall within the selected categories for the application instance. The radar service 252 can link the output of the permanent magnets to the application magnet. The application magnet may then make recommendations for the application.

User interface representations for magnets allow a user to interact with them (e.g. to get information on a specific topic). For example, a user can interact with a magnet via a user interface (e.g., touch screen) to set up, configure and see results of a magnet. If a users pulls two magnet representations near each other (e.g., on a user interface), they'll effect each other. For example, a person pulls their restaurants magnet near their New York magnet on a touch screen display, and in response the two magnets interact and output an intersection of the topics being searched (e.g., restaurants in New York). The client module 250 reports the user input dragging the magnets to the service 252 which updates search parameters to limit restaurant results for restaurants in New York. Magnets may also be “pruned.” For example, a user may personalize a magnet about a singer to show fashion, music, and gossip, but never anything jail-related. The application magnet may receive the same “pruning” and notification of magnet representations by the user to further make the content results to the application more personalized and context relevant.

In one embodiment, magnets are virtual objects that attract similar particles, customized for a user and the user's context. A magnet is typically centered on a topic of interest and attracts a collection of particles related to that topic, filtered and prioritized based on the profile of the user who owns the magnet and the user's current context, for example the time, location, device, activity, and living things like pets and people the user is with.

A particle is a statement or suggestion which may be displayed or outputted. A statement particle has a small amount of textual information such as “Stocks are down right now” or “Mom's birthday is tomorrow.” A suggestion particle may have a link to some digital content such as “Karma Club DJ Night” or “Halo® 2.” Suggestion particles like (i.e. find out the full Karma event details, or go play the game) can be acted upon. For example, a particle may include a Uniform Resource Locator (URL) or magnetic link which a user can select to find details for the event at the Karma Club or sign in online to the game of Halo 2. A user can magnetize a particle, give feedback on a particle, hide, or save a particle.

Particles can have value and actions. Examples of values include a pointer to the actual content, metadata (type, format, thumbnail), pizzazz (by surpassing a relevance threshold, a particle gets pizzazz, which draws attention to it), and relevance (the service system 252 figures out the relevance and applies these values). Some examples of actions include “Go to the content,” “Magnetize this (have it attract similar particles, basically turning it into a temporary magnet),” “Give Feedback on this (thumbs up, thumbs down),” “Hide this (make this go away)” and “Pin this, so I can get back to it.” Other values and actions can also be included. Magnets attract particles related to a particular subject or interest. A digital history may include a trail of particles that a person acted upon or viewed at some point in the past. The digital history may be stored as part of a user's history in his or her user profile data 282. The client service module 250 outputs the most relevant particles based on the current context received from the service 252.

Magnets 264 and the application magnets 263 make use of the recommendation engines 254, 256, 258, 260 to identify content for a user. Additionally, recommendation engines can make recommendations without a magnet involved. Magnets and application magnets use an API 272 to an intelligence system 270 to mine the world of knowledge for information related to one or more topics of interest to a user. Magnets use the recommendation engines to make interesting recommendations for the user about the one or more topics based on the current context of the user, and application magnets make recommendations to the application module 34 for the user for an item which falls within a selected category of data based on the current context of the user. All information and recommendations made by both magnets, application magnets and recommendation engines are then sorted by the relevancy engine 264 and provided to the radar client 250 for the user or in the case of a requesting application instance to the application module 34 for that instance.

In one embodiment, magnets generate events which trigger filtering. As described above, magnets are software processes that search for content relative to a seed. One or more magnets will search for content based on a seed topic, such as the topics of interest to the user. When content is found, the magnets will create a database entry and generate an event associated with that database entry. The content identified is used to create the database entry which is stored and used as part of a filtering process to potentially identify data to be pushed to the user. The event will trigger the filtering.

The recommendation engine (e.g. 254, 256, 258, 260) determines whether a recommendation may be made for a user based on database entry associated with the event and context data for the user. Data gathered and stored by other magnets for the user can also be accessed as a basis for determining whether to make a recommendation. Additionally, context data for users who are linked in data as friends and family or contacts of the user will also be included in the analysis. (The user may have indicated friends, family and contacts in one or more applications such as an email application, social networking application, instant messaging application, etc.) If a recommendation is generated, then the recommendation is pushed to a user either by a client module 250 or an application 34. In one embodiment, if the magnet that generated the event is an application magnet, a generated recommendation is sent via the API 286 to the one or more applications 34 associated with the event generating application magnet. In another example, if the magnet that generated the event performs searching for an application magnet, the application magnet can generate an event based on the other magnet's database entry, so a recommendation goes to its associated application 34 if one is generated. If no recommendation is identified, then no content is pushed. Examples of a recommendation can include informing the user of a sale at a store, a show at a theater, a concert, etc.

In one embodiment, magnets and application magnets make use of the recommendation engines to identify content for a user and the one or more instances of relevancy engines scores each item of content based on its perceived relevancy to the current context of a user. In one embodiment, the relevancy engine 264 provides a numerical relevancy score based on how pertinent the item content is to the current context of the user. For example, a restaurant recommendation may get a higher relevancy score between 3-5 PM, then at midnight. Similarly, information about a football team may receive a higher relevancy score during the football season than between seasons. Information about a band the user is currently listening to, will get a higher score, than another band or other content related to work.

As noted above, the radar service 252 communicates with the intelligence system 270 via an API 272. The intelligence system 270 creates, obtains and stores information about data available to the radar service 252. In one embodiment, the radar service 252 is implemented by a set of one or more computers (e.g., a server farm) and the intelligence system 270 is implemented by a different set of one or more computers (e.g., a server farm). In other embodiments, one or more of the same computers can implement both the radar service 252 and the intelligence system 270.

In one example, data base management software 218 may be contacted by the radar service via the API 272 to access data from the intelligence system 270 which includes a public index 274, a datastore or index for ads and offers 278, a private index 280 and user profile data 282. The public index 274 may be an Internet search index of web sites on the World Wide Web. The private index 280 includes a separate index of private sites for each user. For example, each user will have a private index which provides information about their social networking pages, email, contacts, etc. In some embodiments, the user logins to the radar service via a single sign-on procedure allowing the radar service to maintain sessions with the user's private accounts. The ads and offers datastore 278 provides a list (e.g. with a pointer to or the actual content) of advertisements and offers to consumers that are available and which may be selected if relevant to a user's context. User profile data 282 stores information known, e.g. knowledge base, and inferred, e.g. inferences for each user as well as context data and history including a digital history for the respective user.

In one embodiment, the intelligence system 270 includes an inference engine 283, which is software that guesses information about users based on their behavior. The inference engine can provide context information for a user that includes an intent or state of being of a user derived from an inference based on an action of the user. For example, if a user is reading about a restaurant, the inference engine may assume the user is desiring to eat (e.g., the user is hungry). The response may be to show the user comments from a celebrity “friend” of a restaurant nearby that serve the food the user was observed to eat in the past. The public index 274, ads and offers store (or index) 278, and the private index 280 are created based on crawling or searching on the World Wide Web, social networking systems, collaborative services, multiplayer game services, search engines, movie and music distribution services, purchase systems, text messages, call history, e-mail accounts, examples of which are illustrated as feeds 284 and/or other networks or sources.

In operation, the magnets 265 and application magnets 263 will utilize the recommendation engines 254, 256, 258, 260, the public index 274, the ads and offers store (or index) 278, the private index 280 and the user profile data 282 to identify content of interest to the user. The relevancy engine 264 provides a relevancy score for the items found based on the user's current context. Items of content closest to the user's current context will be given a higher score. Items with the higher scores will be pushed to the radar client module 250 on a user device by the cloud based radar service 252.

The processes, software components or the functionality they provide may be embodied or stored as code, software, instructions, firmware, or the like on processor readable storage media and which can be executed by a processor. An example of processor readable storage media are a computer readable storage medium such as memory, whether in a volatile or non-volatile form, removable or non-removable. Furthermore, the particular naming and division of the modules, applications, software components, and other aspects are not mandatory, and are used for illustrative purposes. The mechanisms that implement the technology or its features may have different names, divisions and/or formats.

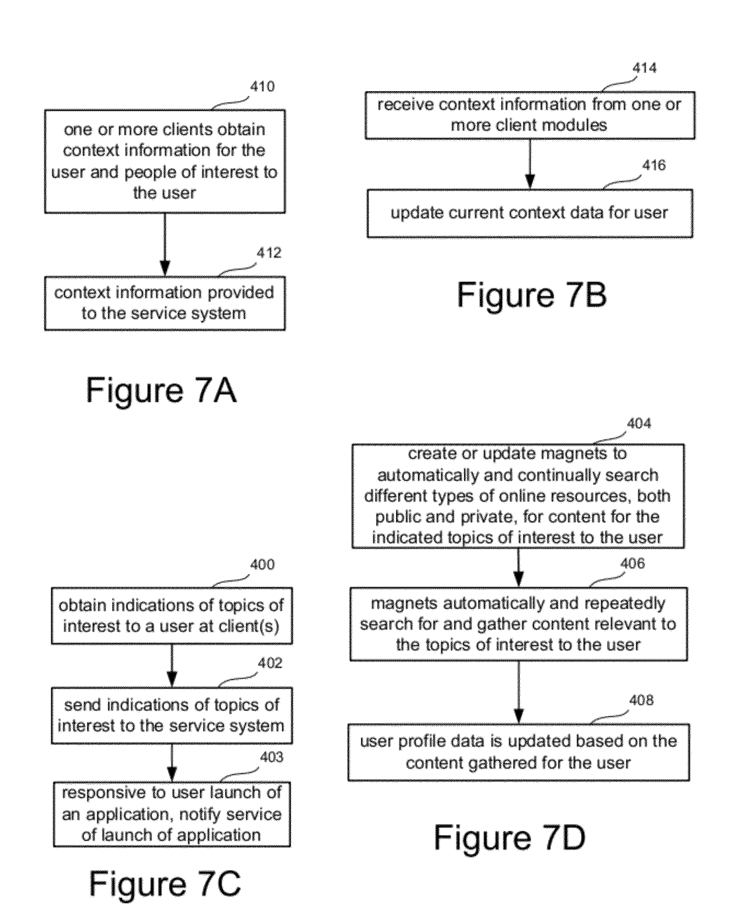

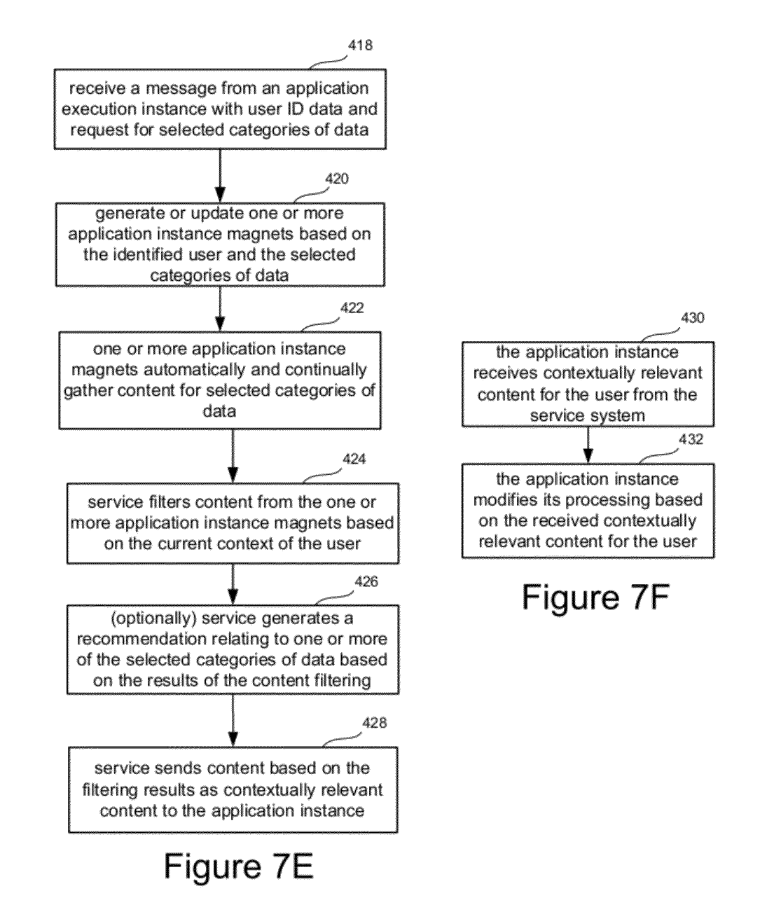

FIGS. 7A through 7F represent functions which may be performed in a service embodiment such as that of FIG. 6. The functions are being performed continuously and concurrently as user contexts and topics of interest may change while launching and exiting different applications.

FIG. 7A is a flowchart of a method by which a service client module provides user context information to the service for aggregating and distributing context relevant content. In step 410, one or more client modules executing on one or more client devices obtains context information for the user and people of interest to the user. This context information may be obtained by interaction with the user, in a manner passive to the user or in a manner active to the user or a combination of these. Examples of context information were discussed above, for example in relation to FIGS. 3 and 4. The one or more client modules execution on the various devices associated with the user in step 412 provide the context information to the service system.

FIG. 7B is a flowchart of a process by which the service updates the current context for a user. The service 252 in step 414 receives the context information from the one or more client modules and updates current context data for the user in step 416.

FIG. 7C is a flowchart of a process by which a service client module indicates user activity to a service for aggregating and distributing context relevant content. One or more service client module 250 in step 400 obtains indications of topics of interest to a user and in step 402 sends the indications of topics of interest to the service system. For example, a client module (32, 250) may upload to the service information such as the examples depicted in 83, 85 and 87. A gaming console 87 uploads updates to game statistics, any new people played with during a gaming session, which game the user is currently playing. A cell phone or smartphone 82 uploads a change to the calendar, search terms in an Internet search just used, and an updated call history and geographic location data. A client module 32 executing on the desktop computer 84 updates when an application has been exited, and that the user has purchased plane tickets to Aruba for use in two months. These are all examples of indications of topic of interest to a user. For example, the plane ticket purchase may indicate passively an interest to changes in airport security regulations on what passengers may pack and an interest in things to see and do in Aruba. By interfacing with the service, an application can leverage the knowledge base about a user which the service develops based on information collected from a diversity of devices and other applications associated with the user.

In particular, the client module may in step 403, responsive to user launch of an application on the client device the client module is executing on, notifies the service of launch of the application. The service may initiate contact to the application with a message to let the application know the service is available. In other examples, the application instance initiates the contact. The client service module may not be executing on the client device a user has launched the application upon, but the service may be active on another device associated with the user. Furthermore, the service 252 may still provide content to a requesting application module 34 even though the user is not currently logged into the service, although the content provided may be based on history from the various online resources the user uses rather than the current context of the user.

FIG. 7D is a flowchart of a process by which the service searches for content for topics of interest to the user based on the indicated user activity. In step 404, the service continually creates and updates magnets to automatically and continually search different types of online resources, both public and private, for content for the topics of interest to the user. In step 406, magnets automatically and repeatedly search for and gather content relevant to the topics of interest to the user and in step 408, the user profile data for the user is updated based on the content gathered for the user.

FIG. 7E is a flowchart of a process by which the service processes a request from an application instance for data related to selected categories of data. The service 252, either via an interface to a client module or a server of the cloud based service receives a message from an executing application instance with user identification (ID) data and a request for data of or related to selected categories of data as in step 418. The user ID data may be an IP address or the application may have more information such as a name. Based on this information, the service system identifies the user, and in step 420 generates or updates one or more application instance magnets based on the identified user and the selected categories of data.

In step 422, the application instance magnet automatically and continually gathers content for selected categories of data. The service filters content from one or more application instance magnets based on the current context of the user in step 424. Optionally, in step 426, the service generates a recommendation relating to one or more of the selected categories of data based on the results of the content filtering. In some examples, the recommendation may be based on private preference data of the user from an application different than the application. For example, a user's preference for types of restaurants, e.g. vegetarian, South Indian, Italian, may have been inferred from contacts for restaurants in his e-mail application which is a private resource accessible only by using his login credentials.

In step 428, the service sends content based on the filtering results as contextually relevant content to the application instance. FIG. 7F is a flowchart of a process by which an application receives and processes contextually relevant content from the service. In step 430, the application instance receives contextually relevant content for a user from the service system, and the application instance modifies its processing based on the received contextually relevant content for the user in step 432.

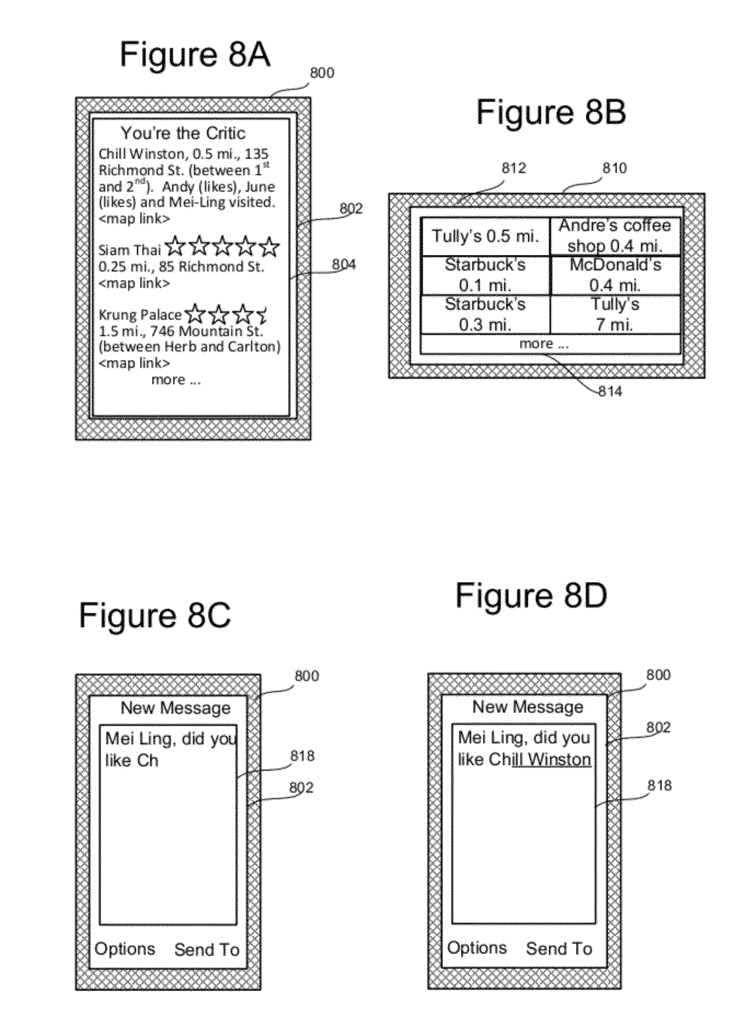

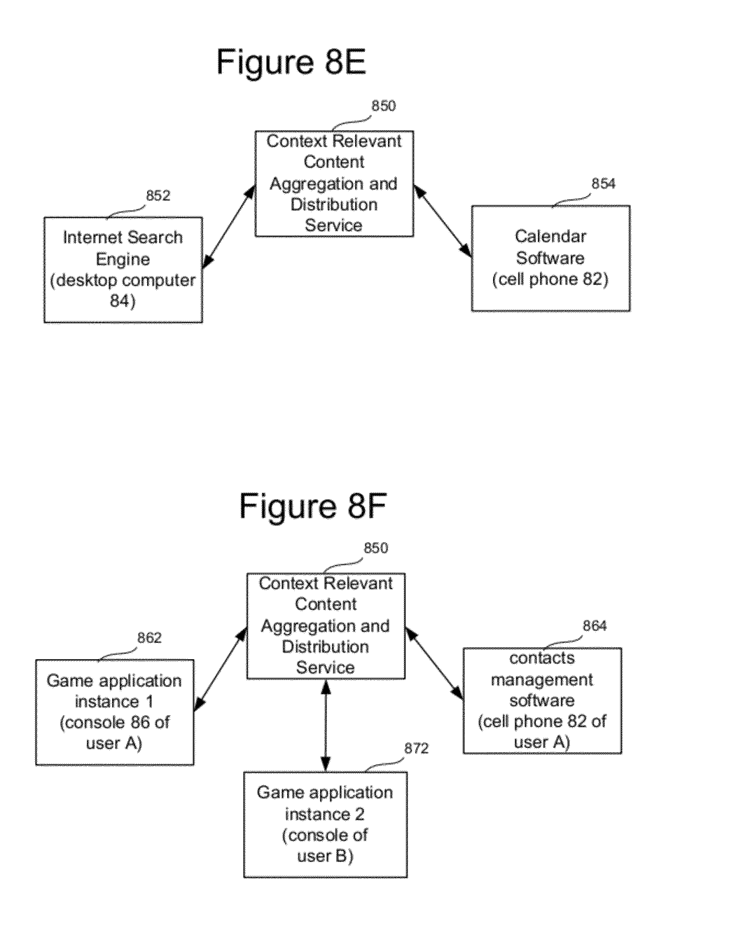

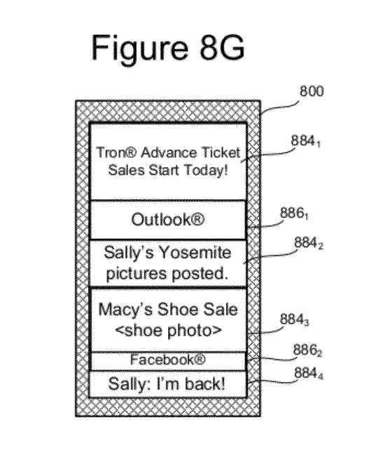

FIGS. 8A through 8F illustrate various examples of how an application may modify its processing to provide personalized and relevant content to a user.

FIG. 8A illustrates an example of a website for consumer reviews of products and services outputting content which is personalized and relevant to the context of a user. An example of such a website is Yelp! For illustrative purposes, an example of a fictitious such consumer review site, “You're the Critic” is presented on a mobile smartphone 800 of a user named “Ryan”. The smartphone 800 has a display 802 on which personalized and relevant content is displayed by the “You're the Critic” application. The displayed personalized content is based on content received from an embodiment of the context relevant content aggregation and distribution service.

As background for this example, Ryan is visiting Vancouver for the weekend. Before he leaves his hotel to explore the city, he launches the “You're the Critic” application on his mobile smartphone 800. The You're the Critic application instance created by the launch sends a message to an API of the service like API 286 for the radar service 252. Based on user ID data like an IP address for the smartphone and location data like a cell tower Ryan's smartphone is communicating with or a WiFi connection point identifier in the user ID data, the radar service 252 identifies Ryan is in Vancouver and his hotel. The consumer review application has requested data from the category of restaurants. An application magnet 263 or other content search software process is launched to find restaurant relevant to Ryan in Vancouver and preferences for restaurants in Vancouver identified in Ryan's user profile data 282. Online resources having data about Ryan's “friends” may report to the application magnet present or past activity at restaurants in Vancouver by Ryan's friends as well. The service sends back a message to the application instance that Ryan likes That food the most, and that three of his friends, Andy, June and Mei-Ling have visited Chill Winston restaurant in Vancouver. The service also identifies to the consumer review application that Andy and June gave Chill Winston a like recommendation in their social networking accounts. Ryan is not currently logged into his social networking account on his mobile or elsewhere, and neither are Andy or June, but he has friend status in Andy and June's accounts so he can see their likes and dislikes preference data. If Ryan is logged into the radar service, the most current information from private accounts can be accessed by the service in providing content, e.g. a recommendation to the application. The service provides a recommendation of Chill Winston with the friend data and a relevancy score to the consumer review application; and another recommendation with a lower relevancy score of That as the preferred food type. Additionally, the service provides context information that Ryan does not have his car with him. The service need not share why but may have deduced this from no car reservation noted and the fact that Ryan flew to Vancouver.

Based on the personalized and contextually relevant content the review site application instance (e.g. current process or session) has received, and the fact that it is around dinner time in Vancouver, the application prioritizes Chill Winston due to its higher relevancy score and being within walking distance and then prioritizes That restaurants by distance and the site's standard rating system.

FIG. 8B illustrates an example of a navigation application providing personalized and context relevant content. An example of such a navigation system is a GPS navigation system device 810 which may be operated within an automobile or separately therefrom. GPS navigation system may provide on its display 812 recommendations on places like gas stations, coffee shops etc. in an area where a user is driving or otherwise navigating. The service can provide context relevant content to which the GPS system may not have access. The service can determine based on activity monitoring that the driver is typically accompanied by a passenger. The passenger may be a user of the service as well or the service has formed a user profile for the passenger based on client modules the passenger interacts with, for example at school or work. Based on purchase transaction history, the service knows the driver does not frequent coffee shops that much, but that the passenger does frequent these shops a lot and which is her preferred brand.

When the driver selects coffee on the GPS touchscreen, the navigation system contacts the service and the service provides context information that the driver is driving with a passenger, a person in a vicinity of the user, and provides a recommendation that the passenger's favorite brand of coffee is Tully's®. Additionally, the service may provide information on their destination (e.g. work, school) and how much time they have available for stopping for coffee on their way. For example, it is a Tuesday, and Tuesday classes start a half hour later. The navigation system provides a display view 814 on the display of the mobile device 812 which prioritizes the Tully's brand coffee shop, perhaps based on a relevancy score for the recommendation even though a little farther away (0.5 ml) than other coffee shops like Starbuck's (0.1 ml. and 0.3 ml.), Andre's coffee shop (0.4 ml.), and McDonald's (0.4 ml.) The next nearest Tully's at 7 ml. is also displayed to give the passenger a sense of the distance to the next location of her favorite. In this example, the context of the user driver includes a physical location and that one or more people are present within a vicinity of the user. Responsive to receiving contextually relevant information about the personal preferences for coffee of the passenger present within a vicinity of the driver, the GPS application outputs content on its display which is accessible by the passenger as well as the driver and which is personalized in that the display view prioritizes the coffee preference of the passenger as aided by a relevancy score from the service.

FIGS. 8C and 8D illustrate an example of a predictive texting application taking advantage of personalized and relevant context information to improve its processing for a user. Ryan decides to text Mei-Ling to see if she liked or disliked Chill Winston. The predictive text application has contacted the radar service 252 or a service client module 250 executing on the phone and has requested context information for the user. Ryan's location in his hotel near Richmond St. is sent to the predictive text application. Additionally, recently tagged items Ryan has accessed online resources about may be sent including a tagged data item for “Chill Winston.” As shown in FIG. 8C, Ryan is typing a text message 818 on the display 802 and has typed “Ch”. Responsive to the “Ch” and the context information and optionally the data tag on Chill Winston, the predictive text software offers the rest of the letters, “ill Winston” as a suggestion as indicated by the underline.

FIG. 8E illustrates an example of a service 850 providing personalized content to an Internet search engine application 852 executing on a user's desktop computer 84 with information in a calendar software application the user keeps separately on her cell phone 82 and which is not able to be synched with the calendar application on her desktop. Her cell phone may not be a smartphone and lacks a USB port for example. Her phone calendar software 854 indicates she is scheduled to be in a certain part of town at 6 p.m. The client module 250 on her desktop computer 84 has been idle as usual between 12 noon and 12:30 p.m. It is now 1 p.m. The user has started searching for Italian restaurants based on the zip code of where she will be at 6 p.m. in a large city so the results will be numerous and may not be as close as desired.

The service 252 with the assistance of the inference engine of the intelligence system 270 makes an inference she is looking for restaurants near the hotel where her friend, also a service user, has registered. The service provides the Internet search engine with the street address of the hotel and dinner as additional recommended seed search terms. This way the engine 852 may present Italian restaurants serving dinner rather than lunch and their dinner menus rather than lunch menus. The service may also provide “southern Italian” as a suggested search term based on food preferences stored in the friend's account with the service. The search engine uses the search terms and displays information on restaurants near the hotel serving dinner, and the hotels are prioritized for southern Italian cuisine and Italian cuisine.

The example in FIG. 8E leverages the service's ability to receive content and/or derive content from one application another application is not in communication with to provide personalized and contextually relevant content to the other application. Additionally, the example of FIG. 8E illustrates that the service determines that the context of the user at the relevant dinner time period is scheduled to include her friend, and the relevant and personalized content for the friend is also provided. The search engine outputs content which is personalized and relevant to both the friend and the user.

FIG. 8F is an another example of a service system like the embodiments in FIGS. 1, 2, 3 and 6 providing contextually relevant and personalized content for a user to a first application derived from data from a second application the first application is not in communication with.

In this example, user B is listed in the contacts management software of the cell phone 82 of user A, but is not listed in the contacts or otherwise identified as a person in someway related to user A in data stored by either the console 86 or an online gaming service. Both user A and user B have user accounts with the radar service and are playing the same game application online at the same time. The users are unaware of each other's gamer identities. Game application instance 1, 862, and game application instance 2, 864, cannot or are not currently communicating with the contacts management software of user A's cell phone. However, the service 850 is communicating with all three instances of executing applications, the two game instances and the contacts management software instance 864. As a contact stored in one of user A's devices 82 on which a radar service client module 250 executes, a magnet for user A captures data about user B for user A's account. The online gaming service instance for A may request data for user A through the API 286 or the service can push data to the game application instance 1 as the gaming service has registered previously with the API 286. The service can send a recommendation to game application instance 1 to display a suggestion to user A to invite user B to play the game together. The gaming application may also ask user A if he wishes to add user B to his contact list maintained by the gaming service.

FIG. 8G illustrates an example of a user interface in which one or more application icons depict content the application provides and which is personalized to the user. Application icons may be used to entice a user to their applications by displaying information personalized and relevant to the user's context. In this embodiment, the mobile computing device 800 illustrates tiles as examples of application icons which may be selected for launching their associated applications. For example, there are tiles 886₁ and 886₂ for applications for which contextually relevant content provided by these applications is not currently available or has already been viewed. The user may have just checked her Outlook® e-mail and her Facebook® page. However, examples of overlays to tiles or other icons illustrate display notifications of context relevant content accessible via the associated applications.

A tile icon for a movie ticket purchase smartphone application like one provided by Fandango® displays an overlay 884₁, which may be a particle, including the text “Tron® Advance Ticket Sales Start Today!” Based on searches and websites visited in the last month or so, the content aggregation and distribution service has identified Tron as a topic of interest to the user and has notified the Fandango application that the user is interested in this movie. From context information of the user's residence and work location, and the time of the advance ticket sales starting, information on advanced sales for theaters in the user's environs is contextually relevant to the user and relevant to the user's interests. Either the application may display the notice on its icon or the client module 32 may display it on the tile icon on the user's device for the application.

Additionally, a notification indicating “Sally's Yosemite pictures posted” 884₂ is provided over a Flickr® tile for a contact, Sally, in the user's e-mail account who has been corresponded with a number of times above a trigger level recently. Additionally, an overlay 884₄ including a tweet from Sally, “Sally: I′m back!” is displayed over the Twitter® tile. In another example, the user is currently near a Macy's location where a pair of shoes her browsing and social networking indicates she is interested in are on sale. An overlay 884₃ is displayed over a tile for a web browser like Internet Explorer® with a title “Macy's Shoe Sale” and a photo of the shoes. When the user clicks on the notification, the web browser displays the Macy's webpage for the shoes.

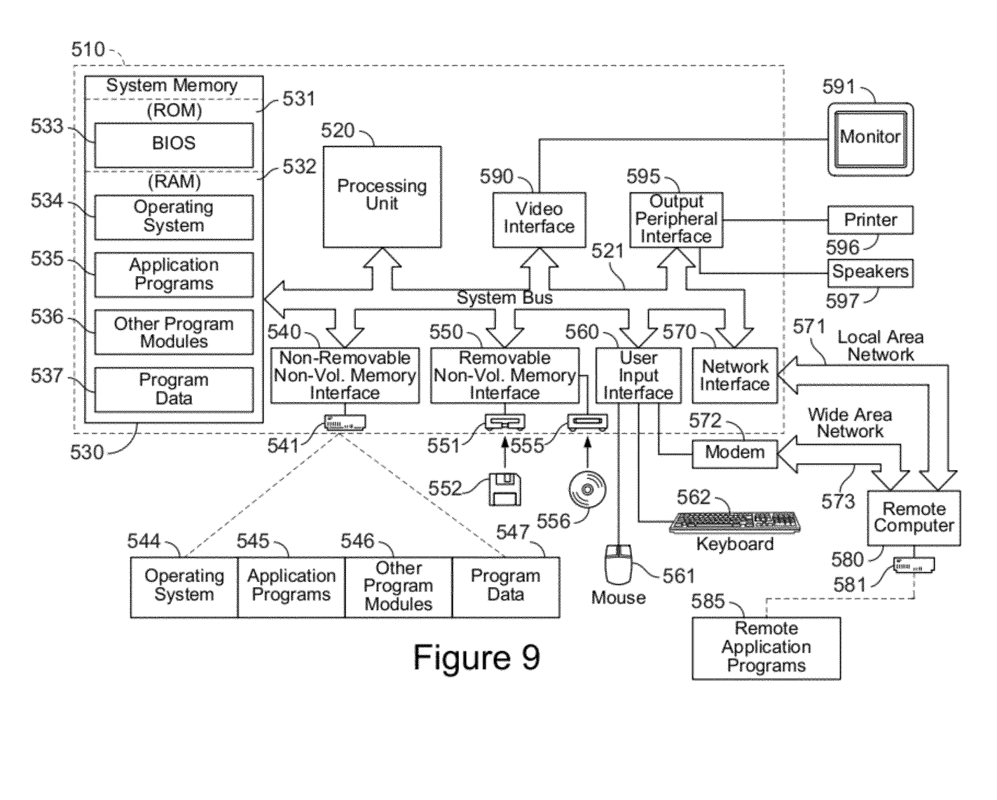

FIG. 9 illustrates an example of a suitable general computing system environment 500 that may comprise for example the desktop, notebook computing device 81, or any of the servers 92, 78. The computing system environment 500 is only one example of a suitable computing environment and is not intended to suggest any limitation as to the scope of use or functionality of the inventive system. Neither should the computing system environment 500 be interpreted as having any dependency or requirement relating to any one or combination of components illustrated in the exemplary computing system environment 500.

The inventive system is operational with numerous other general purpose or special purpose computing systems, environments or configurations. Examples of well known computing systems, environments and/or configurations that may be suitable for use with the present system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 9, an exemplary system for implementing the present technology includes a general purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 may include a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 530 includes computer storage media in the form of volatile and/or nonvolatile memory such as ROM 531 and RAM 532. A basic input/output system (BIOS) 533, containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 9 illustrates operating system 534, application programs 535, other program modules 536, and program data 537.

The computer 510 may also include other removable/non-removable, volatile/nonvolatile computer storage media. By way of example only, FIG. 9 illustrates a hard disc drive 541 that reads from or writes to non-removable, nonvolatile magnetic media and a magnetic disc drive 551 that reads from or writes to a removable, nonvolatile magnetic disc 552. Computer 510 may further include an optical media reading device 555 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 541 is typically connected to the system bus 521 through a non-removable memory interface such as interface 540, magnetic disc drive 551 and optical media reading device 555 are typically connected to the system bus 521 by a removable memory interface, such as interface 550.

The drives and their associated computer storage media discussed above and illustrated in FIG. 9, provide storage of computer readable instructions, data structures, program modules and other data for the computer 510. In FIG. 9, for example, hard disc drive 541 is illustrated as storing operating system 544, application programs 545, other program modules 546, and program data 547. These components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and a pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus 521, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 9. The logical connections depicted in FIG. 9 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communication over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 9 illustrates remote application programs 585 as residing on memory device 581. It will be appreciated that the network connections shown are exemplary and other means of establishing a communication link between the computers may be used.

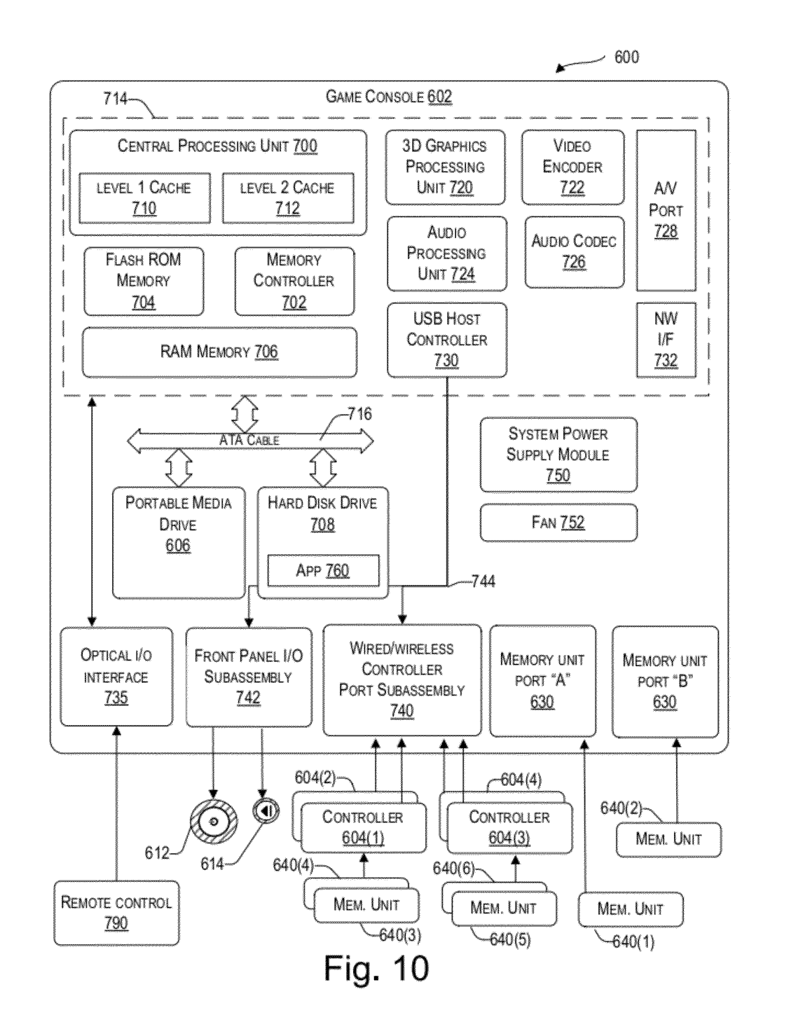

FIG. 10 is a functional block diagram of gaming and media system 600, and shows functional components of gaming and media system 600 in more detail. System 600 may be the same as the computing device 86 described above. Console 602 has a central processing unit (CPU) 700, and a memory controller 702 that facilitates processor access to various types of memory, including a flash Read Only Memory (ROM) 704, a Random Access Memory (RAM) 706, a hard disk drive 708, and portable media drive 606. In one implementation, CPU 700 includes a level 1 cache 710 and a level 2 cache 712, to temporarily store data and hence reduce the number of memory access cycles made to the hard drive 708, thereby improving processing speed and throughput.

CPU 700, memory controller 702, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 700, memory controller 702, ROM 704, and RAM 706 are integrated onto a common module 714. In this implementation, ROM 704 is configured as a flash ROM that is connected to memory controller 702 via a PCI bus and a ROM bus (neither of which are shown). RAM 706 is configured as multiple Double Data Rate Synchronous Dynamic RAM (DDR SDRAM) modules that are independently controlled by memory controller 702 via separate buses (not shown). Hard disk drive 708 and portable media drive 606 are shown connected to the memory controller 702 via the PCI bus and an AT Attachment (ATA) bus 716. However, in other implementations, dedicated data bus structures of different types can also be applied in the alternative.

A three-dimensional graphics processing unit 720 and a video encoder 722 form a video processing pipeline for high speed and high resolution (e.g., High Definition) graphics processing. Data are carried from graphics processing unit 720 to video encoder 722 via a digital video bus (not shown). An audio processing unit 724 and an audio codec (coder/decoder) 726 form a corresponding audio processing pipeline for multi-channel audio processing of various digital audio formats. Audio data are carried between audio processing unit 724 and audio codec 726 via a communication link (not shown). The video and audio processing pipelines output data to an A/V (audio/video) port 728 for transmission to a television or other display. In the illustrated implementation, video and audio processing components 720-728 are mounted on module 714.

FIG. 10 shows module 714 including a USB host controller 730 and a network interface 732. USB host controller 730 is shown in communication with CPU 700 and memory controller 702 via a bus (e.g., PCI bus) and serves as host for peripheral controllers 604(1)-604(4). Network interface 732 provides access to a network (e.g., Internet, home network, etc.) and may be any of a wide variety of various wired or wireless interface components including an Ethernet card, a modem, a wireless access card, a Bluetooth module, a cable modem, and the like.

In the implementation depicted in FIG. 10, console 602 includes a controller support subassembly 740 for supporting four controllers 604(1)-604(4). The controller support subassembly 740 includes any hardware and software components needed to support wired and wireless operation with an external control device, such as for example, a media and game controller. A front panel I/O subassembly 742 supports the multiple functionalities of power button 612, the eject button 614, as well as any LEDs (light emitting diodes) or other indicators exposed on the outer surface of console 602. Subassemblies 740 and 742 are in communication with module 714 via one or more cable assemblies 744. In other implementations, console 602 can include additional controller subassemblies. The illustrated implementation also shows an optical I/O interface 735 that is configured to send and receive signals that can be communicated to module 714.

MUs 640(1) and 640(2) are illustrated as being connectable to MU ports “A” 630(1) and “B” 630(2) respectively. Additional MUs (e.g., MUs 640(3)-640(6)) are illustrated as being connectable to controllers 604(1) and 604(3), i.e., two MUs for each controller. Controllers 604(2) and 604(4) can also be configured to receive MUs (not shown). Each MU 640 offers additional storage on which games, game parameters, and other data may be stored. In some implementations, the other data can include any of a digital game component, an executable gaming application, an instruction set for expanding a gaming application, and a media file. When inserted into console 602 or a controller, MU 640 can be accessed by memory controller 702.

A system power supply module 750 provides power to the components of gaming and media system 600. A fan 752 cools the circuitry within console 602.

An application 760 comprising machine instructions is stored on hard disk drive 708. When console 602 is powered on, various portions of application 760 are loaded into RAM 706, and/or caches 710 and 712, for execution on CPU 700, wherein application 760 is one such example. Various applications can be stored on hard disk drive 708 for execution on CPU 700.

Gaming and media system 600 may be operated as a standalone system by simply connecting the system to monitor 88 (FIG. 1), a television, a video projector, or other display device. In this standalone mode, gaming and media system 600 enables one or more players to play games, or enjoy digital media, e.g., by watching movies, or listening to music. However, with the integration of broadband connectivity made available through network interface 732, gaming and media system 600 may further be operated as a participant in a larger network gaming community.

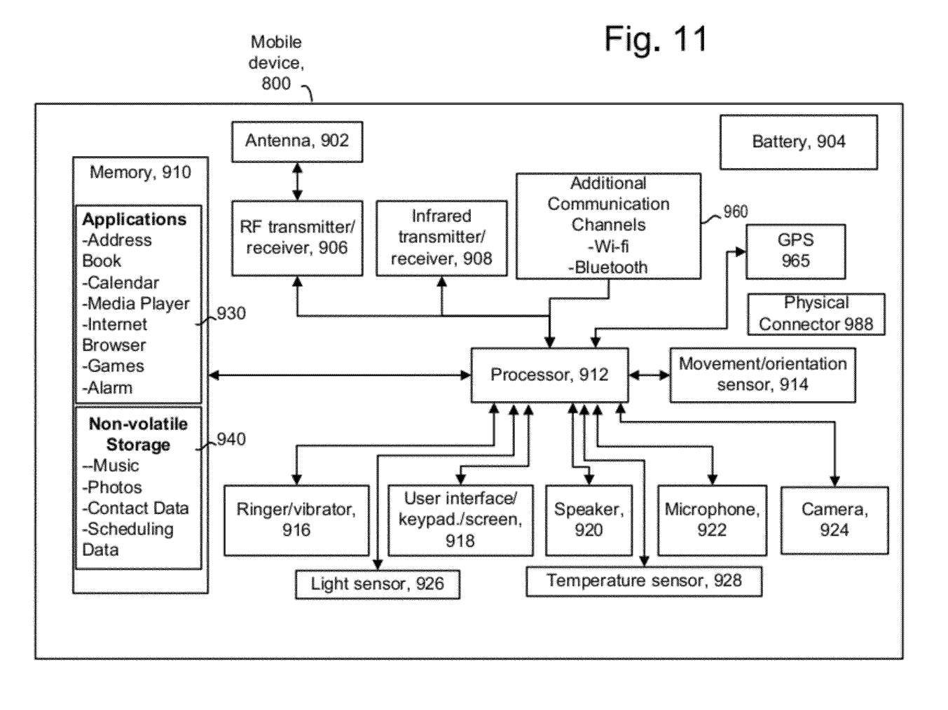

FIG. 11 depicts an example block diagram of a mobile device. Exemplary electronic circuitry of a typical mobile phone is depicted. The phone 800 includes one or more microprocessors 912, and memory 910 (e.g., non-volatile memory such as ROM and volatile memory such as RAM) which stores processor-readable code which is executed by one or more processors of the control processor 912 to implement the functionality described herein.

Mobile device 800 may include, for example, processors 912, memory 910 including applications and non-volatile storage. The processor 912 can implement communications, as well as any number of applications, including the interaction applications discussed herein. Memory 910 can be any variety of memory storage media types, including non-volatile and volatile memory. A device operating system handles the different operations of the mobile device 800 and may contain user interfaces for operations, such as placing and receiving phone calls, text messaging, checking voicemail, and the like. The applications 930 can be any assortment of programs, such as a camera application for photos and/or videos, an address book, a calendar application, a media player, an internet browser, games, an alarm application, other third party applications, the interaction application discussed herein, and the like. The non-volatile storage component 940 in memory 910 contains data such as web caches, music, photos, contact data, scheduling data, and other files.

The processor 912 also communicates with RF transmit/receive circuitry 906 which in turn is coupled to an antenna 902, with an infrared transmitted/receiver 908, with any additional communication channels 1160 like Wi-Fi or Bluetooth, and with a movement/orientation sensor 914 such as an accelerometer. Accelerometers have been incorporated into mobile devices to enable such applications as intelligent user interfaces that let users input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 912 further communicates with a ringer/vibrator 816, a user interface keypad/screen 918, a speaker 920, a microphone 922, a camera 924, a light sensor 926 and a temperature sensor 928.

The processor 912 controls transmission and reception of wireless signals. During a transmission mode, the processor 912 provides a voice signal from microphone 922, or other data signal, to the transmit/receive circuitry 906. The transmit/receive circuitry 906 transmits the signal to a remote station (e.g., a fixed station, operator, other cellular phones, etc.) for communication through the antenna 902. The ringer/vibrator 816 is used to signal an incoming call, text message, calendar reminder, alarm clock reminder, or other notification to the user. During a receiving mode, the transmit/receive circuitry 906 receives a voice or other data signal from a remote station through the antenna 902. A received voice signal is provided to the speaker 920 while other received data signals are also processed appropriately.

Additionally, a physical connector 988 can be used to connect the mobile device 800 to an external power source, such as an AC adapter or powered docking station. The physical connector 988 can also be used as a data connection to a computing device. The data connection allows for operations such as synchronizing mobile device data with the computing data on another device.

A GPS receiver 965 utilizing satellite-based radio navigation to relay the position of the user applications is enabled for such service.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for personalizing application processing for a user by an executing application instance comprising:
receiving contextually relevant and personalized content for a user from a context relevant, content aggregation and distribution service wherein the received content is based upon data which the service has received from a different executing application unavailable to the application instance;
receiving a context for the user in the content; and
outputting content which is personalized to the user and relevant to the context of the user.

2. The method of claim 1 further comprising:
the context of the user includes a physical location of the user and one or more people physically present within a vicinity of the user; and
responsive to receiving contextually relevant and personalized content for the one or more people physically present, outputting content on a display device which is personalized for the one or more people in the vicinity of the user.

3. The method of claim 1 further comprising:
the context of the user includes one or more people; and
responsive to receiving contextually relevant and personalized content for the one or more people, the application outputting content on a display device which is personalized for the one or more people and the user.

4. The method of claim 1, wherein:
the context of the user includes an activity the user is performing other than interacting with the application instance.

5. The method of claim 1, further comprising:
the user is performing an activity by interacting with the application instance;
the application instance receiving an update to the context of the user from the service indicating a person associated with the user, but not in a contact list of the application instance or any application in communication with the application instance, is also performing the activity with another instance of the same application;
the application instance notifying the user about the associated person performing the activity; and
responsive to user input indicating to communicate with the other application instance of the associated person, sending a message to the other application instance of the associated person with a notification that the user is performing the activity concurrently.

6. The method of claim 5 further comprising:
responsive to user input indicating to add the associated person to one or more contact lists by the application instance, updating the one or more contact lists to add the associated person.

7. The method of claim 1, wherein the application instance is one of the group consisting of the following:
a predictive texting application;
a consumer review site for products and services;
a web browser;
a game application; and
contacts management software.

8. A system for providing personalized content about a user to an application instance for context relevant processing comprising:
one or more datastores storing user profile data including current context data for the user;
one or more servers having access to the one or more datastores and being in communication over communication networks with different communication protocols with computer systems executing online resources;
the one or more servers executing software for receiving a request for selected categories of data about the user from an executing application instance;
the one or more servers executing software for searching and gathering content for the selected categories of data about the user from the online resources, wherein the online resources include resources unavailable to the executing application instance; and
the one or more servers executing software for sending the executing application instance content based on the current context data of the user and the content gathered for the selected categories.

9. The system of claim 8 further comprising:
the one or more servers being in communication with one or more client computer devices associated with the user and the servers executing software for determining context data for the user based on context information received from the one or more client computer devices.

10. The system of claim 8 further comprising a database management system executing on the one or more servers for categorizing content aggregated from the online resources into categories and storing the categories of data in the one or more datastores.

11. The system of claim 8, wherein:
the one or more servers execute software including an application programming interface for receiving the request for selected categories of data about the user; and
the one or more servers execute software including an application programming interface for sending the content based on the current context data of the user.

12. The system of claim 11 wherein the categories of data comprise location data, activity data, availability data, history data, and device data about one or more client devices associated with the user.

13. The system of claim 11 wherein the categories of data comprise location data and environmental data.

14. The system of claim 8, wherein:
the one or more servers executing software for searching and gathering content for the selected categories of data about the user from the online resources further comprises
an application magnet which is a software process which searches for and gathers content related to the selected categories of data about the user for a duration of the application instance, and
a relevancy engine for filtering content gathered by the application magnet by determining a relevancy score of the content related to the selected categories gathered by the application magnet to the context data of the user.

15. The system of claim 14, wherein the magnet searches and gathers content for the selected categories of data about the user from online resources private to the user.

16. The system of claim 14 wherein the one or more data stores store a public index of publicly available online resources, and a private index of resources private to the user.

17. One or more processor readable storage devices having processor readable code embodied on the one or more processor readable storage devices, the processor readable code for programming one or more processors to perform a method for providing personalized content about a user to an application for context relevant processing, the method comprising:
automatically and continuously gathering content about one or more topics of interest to a user from online resources executing on computer systems accessible via different communication protocols;
receiving a request from an application for data describing a user's interest in one or more topics and a context for the user;
automatically filtering the content gathered for the user based on the application data request from the application, user profile data and a current user context; and
providing contextually relevant content for the user based on the filtering to the requesting application.

18. The one or more processor readable storage devices of claim 17, wherein:
providing contextually relevant content for the user based on the filtering to the requesting application includes providing a recommendation based on the filtering for one or more selected categories of data of the application data request.

19. The one or more processor readable storage devices of claim 18 wherein the recommendation is based on private preference data of the user from an application different than the requesting application.

20. The one or more processor readable storage devices of claim 17, wherein:
the contextually relevant content includes content based on user data retrieved from another application executing on another user client device associated with the user.
